(19) United States
(12) Patent Application Publication
(10) Pub. No.: US 2011/0157867 A1
(43) Pub. Date: Jun. 30, 2011

(54) DIFFUSION PLATE HAVING MICROSTRUCTURES WITH TWO LENGTHY AND SLANT FACES APPLIED FOR BACKLIGHT MODULE AND OPTICAL DEVICE

(76) Inventors: Chi-Feng LIN, Taipei (TW); Yu-Bin Fang, Taipei (TW); Po-Hua Yang, Taipei (TW)

(21) Appl. No.: 12/647,745

(22) Filed: Dec. 28, 2009

(51) Int. Cl. G02F 1/13357; F21V 11/00; F21V 7/00

(52) U.S. Cl. 362/97.1; 362/355; 362/346

(57) ABSTRACT

A diffusion plate having microstructures with two lengthy and slant faces and its relevant backlight module as well as optical device includes an optical base and a diffusion plate with pluralities of microstructures; wherein, the microstructures on the optical base are located by different allocation, and an angle is defined by the cooperation of two longitude and slant faces of each microstructure. The above arrangements substantially impinge on controlling the light return and transmission of the backlight module or the optical device including a brightness enhancement film, a light source, and a reflecting plate disposed thereon, thereby increasing the uniformity of backlight through the optical reflection and refraction.

### BACKGROUND OF THE INVENTION

1. Field of the Invention

The present invention relates to a diffusion plate having microstructures each with two longitude and slant faces, which includes an optical base and a diffusion plate with pluralities of microstructures for efficiently handling the light return and transmission, thereby increasing the uniformity of backlight.

2. Description of the Related Art

The conventional optical diffusion plate mainly makes use of the structures formed in a convex feature, multiples diffusion particulates, or the ones configured by a prismatic contour for acting the light spreading/diffusion, refraction, and transmission.

The closer prior inventions, ^{┌}STRUCTURE OF DIRECT TYPE BACKLIGHT MODULE WITH HIGH UNIFORM EMITTING LIGHT_{┘} issued by U.S. Pat. No. 7,347,585B2 and ^{┌}STRUCTURE OF DIRECT TYPE BACKLIGHT MODULE WITH HIGH UNIFORM EMITTING LIGHT_{┘} issued by U.S. Pat. No. 7,213,936B2, mainly directed to a direct type backlight module forming in a design of lenticular lens for acting as a diffusion plate. Wherein, the lenticular is against the light source, and the light of lamp is scattered and the light far away the curvature of the lenticular lens is enlarged for reducing the scatter effect and thence attaining the uniformity. The other lenticular lens also can be designed for light location and distance. Each lenticular lens is against the location of light, and the incident light can be reflected through the angle of microstructure surface at the entrance facet.

Other prior inventions, ^{┌}OPTICAL FILM HAVING A STRUCTURED SURFACE WITH RECTANGULAR BASED PRISMS_{┘} issued by U.S. Patent Publication No. 20060103777A1 and ^{┌}OPTICAL FILM HAVING A STRUCTURED SURFACE WITH OFFSET PRISMATIC STRUCTURES_{┘} issued by U.S. Pat. No. 7,220,026B2, mainly directed to optical films having a first surface and a structured optical surface, the structured surface has multiples prismatic structures each provided with at least two first and second sides. Further, the first side has a length different from that of the second side. Wherein, each prismatic structure comprises five substantially planar surfaces and four surfaces attached to the base, and each of the four surfaces are positioned to angle in from the base toward the fifth surface.

Another prior invention, ^{┌}optical films and application of the same_{┘} issued by R.O.C. Patent Publication No. 200846712, mainly directed to an optical film at least including a base, a plurality of polygonal design of convex structures, and a plurality of diffusion particulates. Wherein, the convex structures are disposed on a surface of the base. The base and the convex structures are preferably configured by materials pervious to light, and the diffusion particulates are scattered among the base and the convex structures. The refraction coefficient of the pervious material is different from the refraction coefficient of the diffusion particulates.

The disadvantages attendant on the above conventional inventions are described below:
1. The angle of the convex structure and the allocation of the diffusion particulates facilely interrupt the path of the light, so as to attain a poor reflection and transmission of the light.
2. The typical diffusion plate requires complicate structures, which however increases the design and manufacturing costs.
3. The angle and square arrangement of the optical surface of the diffusion particulates would be restricted by the interruption and would be difficultly varied in accordance with the reflection and the refraction.
4. The typical diffusion plate applied to a thin backlight module or other optical devices can not efficiently increase the average luminance and the uniformity of the backlight module, which limits the optical quality of the product.

The aforementioned optical diffusion plates may be capable of satisfying the basic demands and effects upon the light diffusion, the refraction, and the transmission, whereas they still required improvements by practically concerning the adaptation, the optical efficacy, the economic effectiveness, and the industrial proprietary.

### SUMMARY OF THE INVENTION

The object of the present invention is to solve the typical optical diffusion plate whose backlight design unintentionally limits the utility technique and lacks of sufficient adaptation, optical efficacy, economic effectiveness, and industrial proprietary. It is a primary object to increase the uniformity of backlight; it is another object to enhance the control over the light return and transmission, add the durability of the device, streamline the configuration, and promote a thin volume beneficial of its function, adaptation, as well as application. Therefore, the present invention not only attains basic optical light diffusion, refraction, and transmission but satisfies the practical development and demands of industrial application.

To a subjective and objective view, the domestic and foreign patents are currently failed to disclose the technique as the same as the present diffusion plate with microstructures with two longitudinal and slant face and its relevant backlight module and optical device for a superior optical capability and backlight characteristic. Involving to an application scope, the present invention possess the predominant advantages in the market as the configuration thereof could preferably adapt to the backlight module and the optical industrial, therefore the present invention could inevitably provide the production and marketing of backlight module and optical technique fields with the magnitude of development.

The present invention pertains to a diffusion plate having microstructures with two lengthy and slant faces and its relevant backlight module as well as optical device includes an optical base and a diffusion plate with pluralities of microstructures, whereby, the present invention is capable of controlling the return and transmission of light for promoting the backlight uniformity.

Accordingly, a diffusion plate having microstructures with two lengthy and slant faces in accordance with the present invention includes an optical base and pluralities of microstructures; wherein, the optical base has a first surface, a second surface disposed relatively to the first surface, and a plurality of sides connecting the first and the second surfaces. Each of the microstructures, formed on the first surface of the optical base, has a first bottom border, a second bottom border, and an arcuate arris. The first bottom border and the second bottom border are formed in an expandable arc shape. The first bottom border intersects with the second bottom border at a first interface and a second interface, respectively. The arcuate arris extend from the first interface to the second interface. A first long-bevel face is defined between the arcuate arris and the first bottom border, and a second long-bevel face is defined between the arcuate arris and the second bottom border. The first long-bevel face and the second long-bevel face are cross-sectionally shaped in a slope.

Further, a backlight module having a diffusion plate with microstructures in accordance with the present invention includes a diffusion plate, at least one brightness enhancement film, a light source, and a reflecting plate; wherein, the diffusion plate has includes an optical base and pluralities of microstructures; wherein, the optical base has a first surface, a second surface disposed relatively to the first surface, and a plurality of sides connecting the first and the second surfaces. Each of the microstructures, formed on the first surface of the optical base, has a first bottom border, a second bottom border, and an arcuate arris. The first bottom border and the second bottom border are formed in an expandable arc shape. The first bottom border intersects with the second bottom border at a first interface and a second interface, respectively. The arcuate arris extend from the first interface to the second interface. A first long-bevel face is defined between the arcuate arris and the first bottom border, and a second long-bevel face is defined between the arcuate arris and the second bottom border. The first long-bevel face and the second long-bevel face are cross-sectionally shaped in a slope. The at least one brightness enhancement film covers the optical base with microstructures of the diffusion plate. The light source is disposed under the second surface of the optical base of the diffusion plate. The reflecting plate is disposed below the light source.

Moreover, an optical device having a diffusion plate with microstructures in accordance with the present invention includes a backlight module, a circuit module, and a frame module; wherein, the backlight module includes at least one brightness enhancement film, a diffusion plate, a light source, and reflecting plate. The diffusion plate includes an optical base and pluralities of microstructures; wherein, the optical base has a first surface, a second surface disposed relatively to the first surface, and a plurality of sides connecting the first and the second surfaces. Each of the microstructures, formed on the first surface of the optical base, has a first bottom border, a second bottom border, and an arcuate arris. The first bottom border and the second bottom border are formed in an expandable arc shape. The first bottom border intersects with the second bottom border at a first interface and a second interface, respectively. The arcuate arris extend from the first interface to the second interface. A first long-bevel face is defined between the arcuate arris and the first bottom border, and a second long-bevel face is defined between the arcuate arris and the second bottom border. The first long-bevel face and the second long-bevel face are cross-sectionally shaped in a slope. The at least one brightness enhancement film covers the optical base with microstructures of the diffusion plate. The light source is disposed under the second surface of the optical base of the diffusion plate. The reflecting plate is disposed below the light source. The circuit module electrically connects to the backlight module. The frame module includes a chamber to accommodate the backlight module and the circuit module therein.

Preferably, the first and the second long-bevel faces of the aforementioned diffusion plate, the backlight module, and the optical device are axially reflected with each other by the arcuate arris.

Preferably, the microstructures of the diffusion plate, the aforementioned backlight module, and the optical device are distributed by rows; wherein, each row of the microstructures is aligned with respect to an axis line, and an angle defined between the arcuate arris and the axis line is in the range from 0 degree to 45 degrees. Any adjacent rows of the microstructures are alternatively interlaced with each other or are set by a rectangular distribution.

Preferably, the light source of the aforementioned backlight module and the optical device can be a cold-cathode tube or an LED.

Preferably, the light source of the back light module and the optical device is axially arranged within the range from 0 degree to 90 degrees.

Accordingly, the objectives and purposes of the present invention are described as follows:
1. The microstructures configured by a slant design are capable of controlling the light under the backlight module to throw back and to penetrate through a LED module, so as to increase the uniformity of the backlight module.
2. The side angle and distribution of the microstructures could be varied in accordance with the reflection and the refraction.
3. The overall arrangement and allocation of the microstructures could be varied in accordance with the property and light flux of the light source.
4. The present diffusion plate provided with microstructures applied to a thin backlight module efficiently increases the average luminance and the uniformity of the backlight module.
5. The present diffusion plate provided with microstructures applied to an LCD efficiently increases the average luminance and the uniformity of the LCD.
6. The present diffusion plate provided with microstructures applied to a flat lighting equipment efficiently increases the radiation of the flat lighting equipment.

### BRIEF DESCRIPTION OF THE DRAWINGS

FIG. 1 is a schematic view showing the diffusion plate of the present invention;

FIG. 2 is a schematic view showing the microstructure of the present invention;

FIG. 3 is a lateral cross-sectional view showing the A-A section of the microstructure;

FIG. 4 is a lateral cross-sectional view showing the B-B section of the microstructure;

FIG. 5 is a longitudinal cross-sectional view showing the C-C portion of the microstructure;

FIG. 6 is a first schematic view showing the present microstructures interlaced with each other;

FIG. 7 is a second schematic view showing the present microstructures interlaced with each other;

FIG. 8 is a first schematic view showing the present microstructures in rectangular allocation;

FIG. 9 is a second schematic view showing the present microstructures in rectangular allocation;

FIG. 10 is a schematic view showing the backlight module of the present invention;

FIG. 11 is a first schematic view showing the light path of the microstructure of the diffusion path;

FIG. 12 is a second schematic view showing the light path of the microstructure of the diffusion path; and

FIG. 13 is a schematic view showing the optical device of the present invention.

### DETAILED DESCRIPTION OF THE PREFERRED EMBODIMENTS

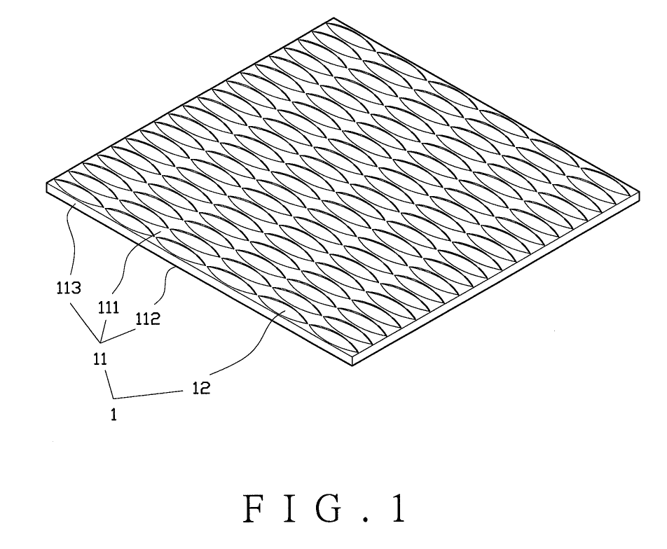

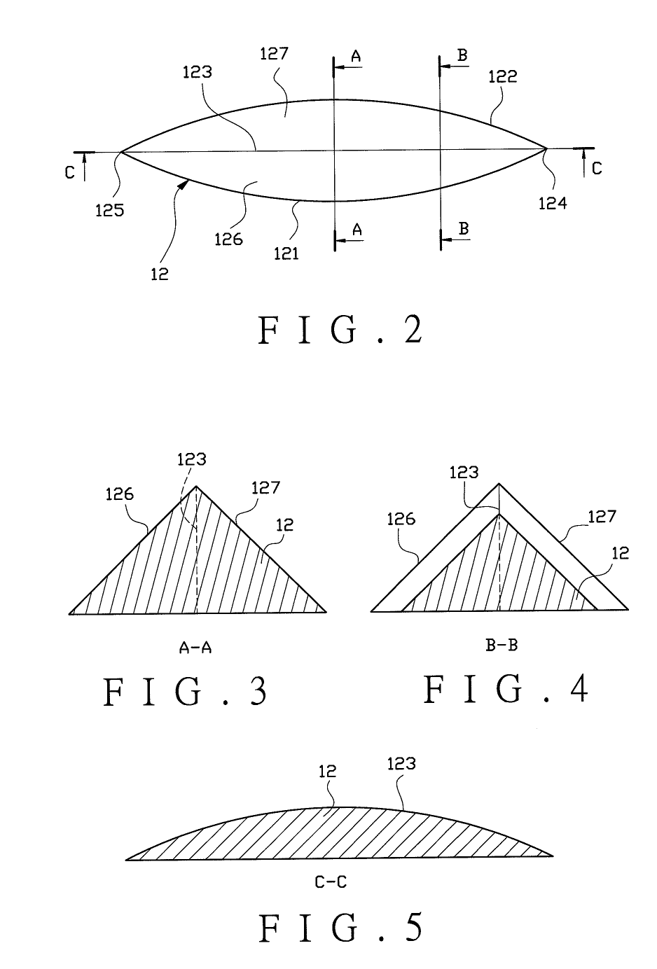

Referring to FIGS. 1 and 2, a diffusion plate 1 having microstructures with two lengthy and slant faces in accordance with the present invention includes:

An optical base 11 has a first surface 111, a second surface 112 disposed relatively to the first surface 111, and a plurality of sides 113 connecting the first surface 111 and the second surface 112.

A plurality of the microstructures 12, formed on the first surface 111 of the optical base 11, each has a first bottom border 121, a second bottom border 122, and an arcuate arris 123. Wherein, the first bottom border 121 is formed in an expandable arc shape and the same to the second bottom border 122 as well. The first bottom border 121 intersects with the second bottom border 122 at a first interface 124 and a second interface 125, respectively. The arcuate arris 123 extend from the first interface 124 to the second interface 125. A first long-bevel face 126 is defined between the arcuate arris 123 and the first bottom border 121, and a second long-bevel face 127 is defined between the arcuate arris 123 and the second bottom border 122, so that the microstructure 12 could be formed with two longitudinal and slant faces.

The first long-bevel face 126 and the second long-bevel face 127 are cross-sectionally shaped in a slope, respectively, and such slope are intersected with the first face 111 of the optical base 11 in cross-section to perform in a triangular. Further, the first long-bevel face 126 and the second long-bevel face 127 are axially reflected with each other by the arcuate arris 123.

Referring to FIGS. 3 and 4 shows a single microstructure 12, in which an A-A section, perpendicular to the arcuate arris 123, is laterally across the middle of the microstructure 12 in cross-section, and a B-B section, perpendicular to the arcuate arris 123, is laterally seated at quarter of the microstructure 12 in cross-section. These two sections respectively show that the microstructure 12 is formed by the first long-bevel face 126 and the second long-bevel face 127 and, that being said, the first long-bevel face 126 and the second long-bevel face 127 are in a specular relationship axial with respect to the arcuate arris 123. The first and the second long-bevel faces 126,127 are intersected at the arcuate arris 123, and two side faces in cross section defined by the first and the second long-bevel faces 126,127 are formed in any random triangular as shown in preferred embodiments below:
1. Non-isosceles triangular: the lengths of the first long-bevel face 126 and the second long-bevel face 127 are not equal, and any of these faces in cross section is formed by an irregular triangular.
2. Isosceles triangular: the lengths of the first long-bevel face 126 and the second long-bevel face 127 are equal, and any of these faces in cross section is formed by an isosceles triangular, which is adopted in one of the preferred embodiment of the present invention.
3. Regular triangular: the lengths of the first long-bevel face 126 and the second long-bevel face 127 are equal, and any of these faces in cross section is formed by an equilateral triangular.

Referring to FIG. 5 shows a single microstructure 12, in which a C-C section, parallel to the arcuate arris 123, is laterally across the middle of the microstructure 12 in cross-section. It clearly performs that the microstructure 12 is commonly formed by the first long-bevel face 126 and the second long-bevel face 127 (also referring to FIG. 2), and the first and the second long-bevel faces 126,127 are intersected at the arcuate arris 123. The arcuate arris 123 is shaped in an arc with a parabolic contour.

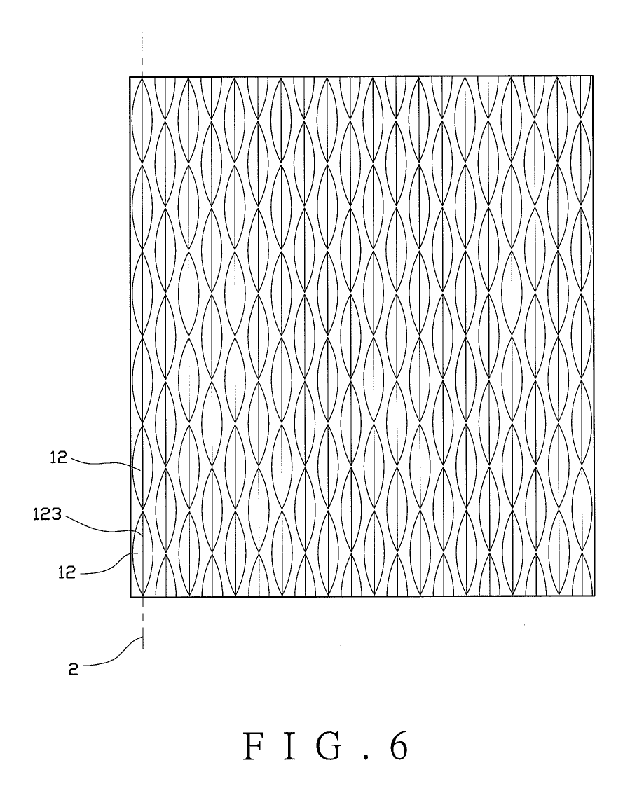

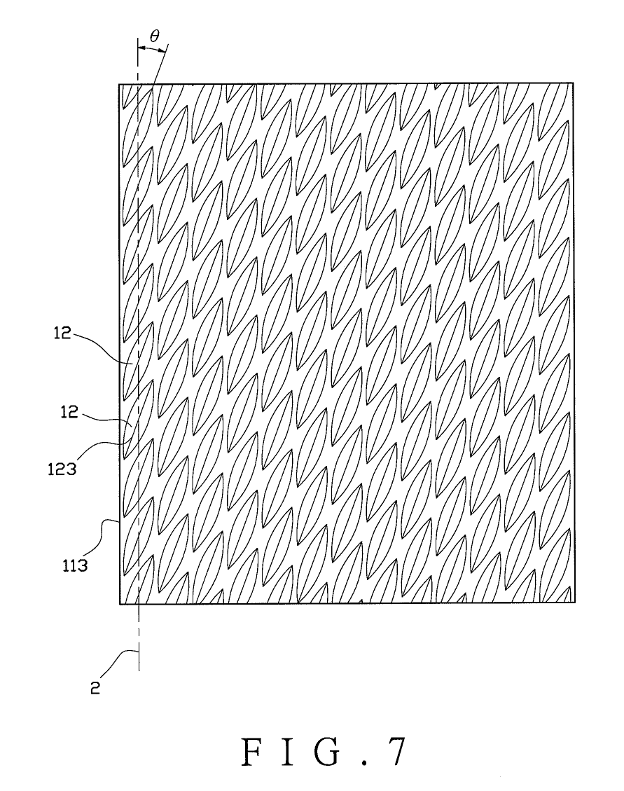

Referring to FIG. 7, the microstructures 12 on the optical base 11 are distributed and interlaced by rows; wherein, each row of the microstructures 12 is aligned with respect to an axis line 2 which alternatively travels along the arcuate arris 123 or parallel to the side 113 of the optical base 11, and an angle θ defined between the arcuate arris 123 of the microstructure 12 and the axis line 2 is in the range from 0 degree to 45 degrees. Referring to FIG. 6 shows that the arcuate arris 123 is not inclined with respect to the axis line 2 for making the angle θ zero.

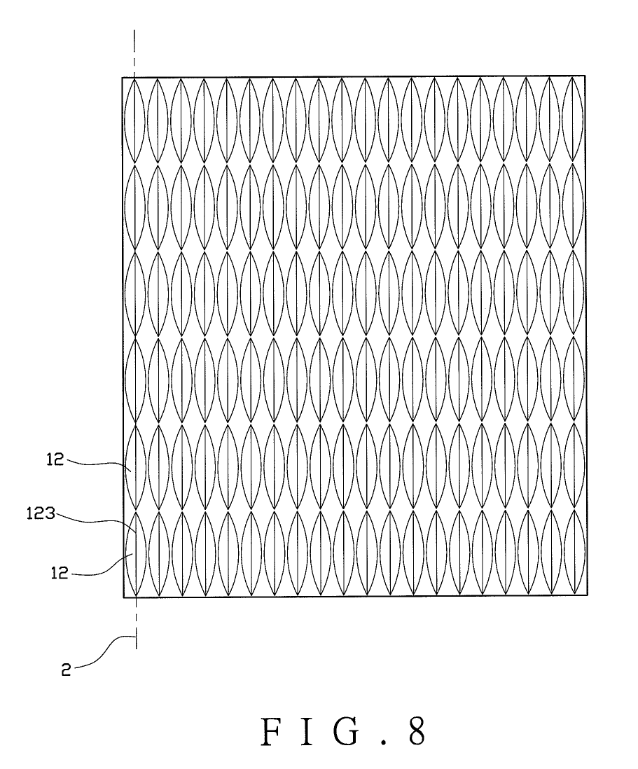

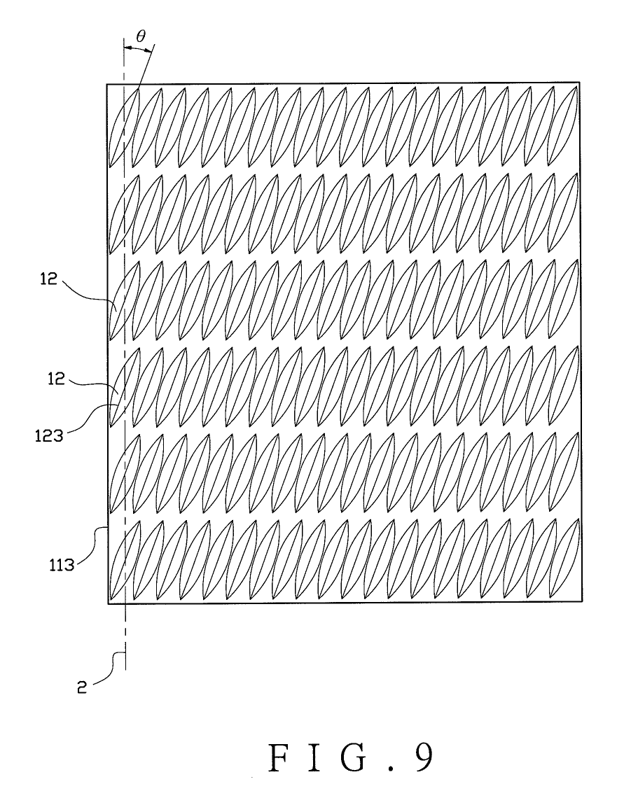

Referring to FIG. 9, the microstructures 12 on the optical base 11 are distributed by rectangular rows; wherein, each row of the microstructures 12 is aligned with respect to an axis line 2 which alternatively travels along the arcuate arris 123 or parallel to the side 113 of the optical base 11, and an angle θ defined between the arcuate arris 123 of the microstructure 12 and the axis line 2 is in the range from 0 degree to 45 degrees. Referring to FIG. 8 shows that the arcuate arris 123 is not inclined with respect to the axis line 2 for making the angle θ zero.

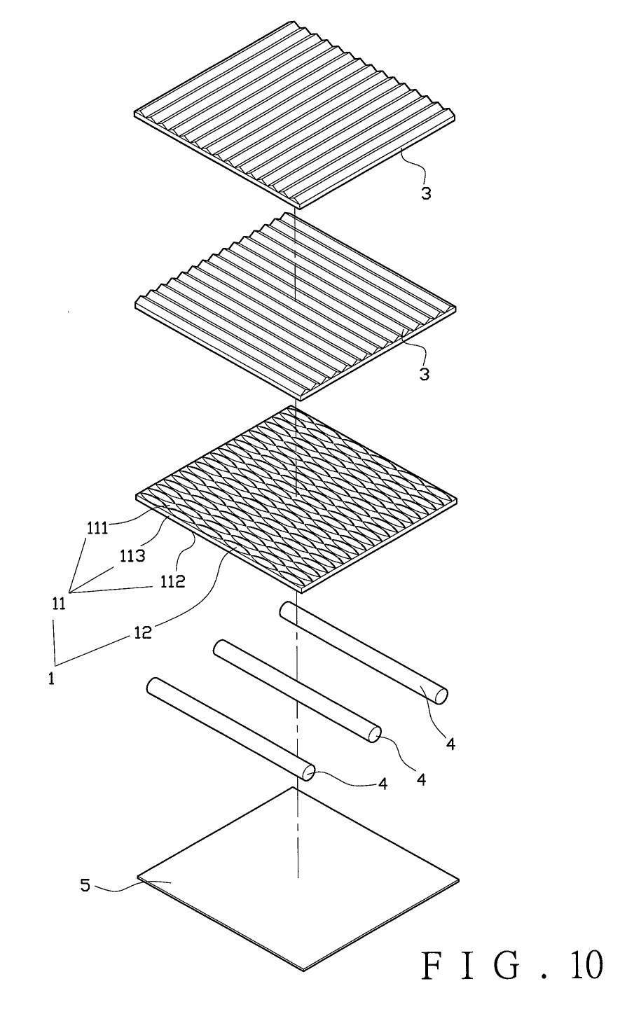

Referring to FIG. 10, a backlight module 6 having a diffusion plate with microstructures in accordance with the present invention includes:

A diffusion plate 1 comprises an optical base 11 and a plurality of the microstructures 12; wherein, the optical base 11 has a first surface 111 and a second surface 112 disposed relatively to the first surface 111. Further, the microstructures 12, formed on the first surface 111 of the optical base 11, each has a first bottom border 121, a second bottom border 122, and an arcuate arris 123. A first long-bevel face 126 is defined between the arcuate arris 123 and the first bottom border 121, and a second long-bevel face 127 is defined between the arcuate arris 123 and the second bottom border 122, so that the microstructure 12 could be formed with two longitudinal and slant faces (also referring to FIG. 2).

At least one brightness enhancement film 3 covers the first surface 111 the optical base 11 with the microstructures 12 of the optical base 11 of the diffusion plate 1.

A light source 4 is disposed under the second surface 112 of the optical base 11 of the diffusion plate 1. Preferably, the light source 4 can be a cold-cathode tube or a LED and be axially arranged within the range from 0 degree to 90 degrees.

A reflecting plate 5 is disposed below the light source 4.

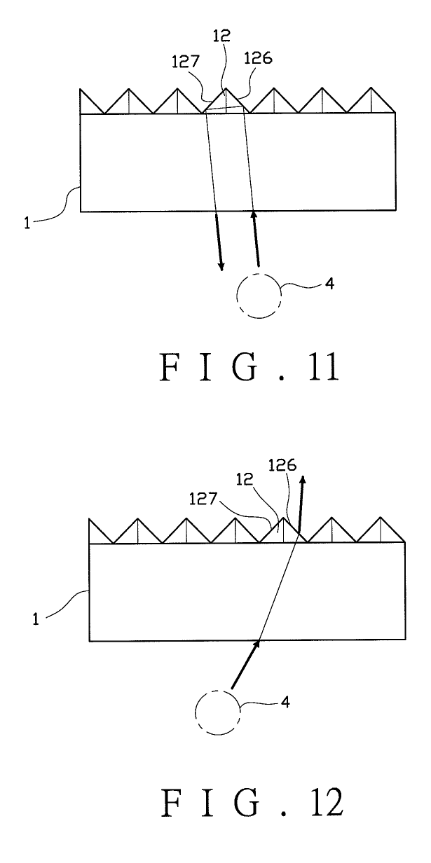

Referring to FIG. 11, while a light of incidence touches the first long-bevel face 126 of the microstructure 12, the microstructure 12 of the diffusion plate 1 right upon the light source 4 causes the light to generate a total internal reflection without refraction to the second long-bevel face 127 and thence throw back downwardly, so as to reduce the brightness strongly impinging on a right top portion of the light source 4.

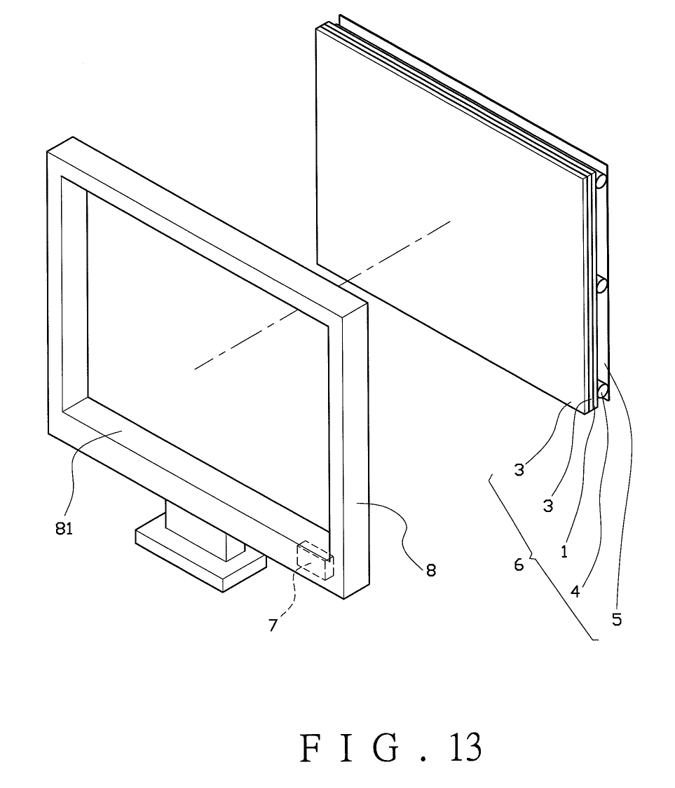

Referring to FIG. 12, while a light of incidence touches the first long-bevel face 126 of the microstructure 12, the microstructure 12 of the diffusion plate 1 right upon the light source 4 causes the light to become refraction and thence penetrate through the diffusion plate 1, so as to increase the brightness directing to a non-right top portion of the light source 4.

Referring to FIG. 13, an optical device having a diffusion plate with microstructures in accordance with the present invention includes:

A backlight module 6 comprises at least one brightness enhancement film 3, a diffusion plate 1, a light source 4, and a reflecting plate 5. Wherein, the diffusion plate 1 as shown in FIG. 2 comprises an optical base 11 and a plurality of the microstructures 12. The optical base 11 has a first surface 111 and a second surface 112 disposed relatively to the first surface 111. Further, the microstructures 12, formed on the first surface 111 of the optical base 11, each has a first bottom border 121, a second bottom border 122, and an arcuate arris 123. A first long-bevel face 126 is defined between the arcuate arris 123 and the first bottom border 121, and a second long-bevel face 127 is defined between the arcuate arris 123 and the second bottom border 122, so that the microstructure 12 could be formed with two longitudinal and slant faces (also referring to FIG. 2). In addition, the at least one brightness enhancement film 3 covers the first surface 111 of the optical base 11 with the microstructures 12 of the optical base 11 of the diffusion plate 1. The light source 4 is disposed under the second surface 112 of the optical base 11 of the diffusion plate 1, and the reflecting plate 5 is disposed below the light source 4.

A circuit module 7 electrically connects to the backlight module 6.

A frame module 8 includes a chamber 81 to accommodate the backlight module 6 and the circuit module 7 therein.

In application, the present invention can be applied to multiples fields, for instance of a thin LCD technique or a flat lighting equipment.

To sum up, the present invention involves in a diffusion plate having microstructures with two lengthy and slant faces and its relevant backlight module as well as optical device, which especially directs to one including an optical base 11 and a diffusion plate 1 with microstructures 12; wherein, the microstructures 12 on the optical base 11 are in different allocation, and an angle is defined by the cooperation of the two longitude and slant faces 126,127 of the microstructures 12. In operation, the aforementioned arrangements, cooperating with a backlight module 6 or an optical device having a brightness enhancement film 3, a light source 4, and a reflecting plate 5, substantially impinge on controlling the light reflection and transmittance of the backlight module, thereby increasing the uniformity of backlight through the optical reflection and refraction. Therefore, the present design preferably attains a superior improvement and promotes an advanced design to the diffusion plate having microstructures with two lengthy and slant faces and its relevant backlight module as well as optical device.

I claim:

1. A diffusion plate having microstructures with two lengthy and slant faces including:
an optical base having a first surface, a second surface disposed relatively to said first surface, and a plurality of sides connecting said first surface and said second surface; and
a plurality of microstructures being formed on said first surface of said optical base; each of said microstructures having a first bottom border, a second bottom border, and an arcuate arris; wherein, said first bottom border being formed in an expandable arc shape, and said second bottom border being formed in an expandable arc shape; said first bottom border intersecting with said second bottom border at a first interface and a second interface, respectively; said arcuate arris extending from said first interface toward said second interface; a first long-bevel face being defined between said arcuate arris and said first bottom border, and a second long-bevel face being defined between said arcuate arris and said second bottom border; said first long-bevel face and said second long-bevel face in cross-section being formed by a slope contour.

2. The diffusion plate as claimed in claim 1, wherein said first long-bevel face and said second long-bevel face are axially reflected with each other by said arcuate arris.

3. The diffusion plate as claimed in claim 1, wherein said microstructures are distributed by rows; wherein, each row of said microstructures is aligned with respect to an axis line, and an angle defined between said arcuate arris and said axis line is in the range from 0 to 45 degrees.

4. The diffusion plate as claimed in claim 3, wherein said adjacent rows of said microstructures are in an interlaced distribution.

5. The diffusion plate as claimed in claim 3, wherein said microstructures are in a rectangular distribution.

6. A backlight module having a diffusion plate with microstructures including:
said diffusion plate comprising and optical base and a plurality of microstructures; wherein said optical base having a first surface, a second surface disposed relatively to said first surface, and a plurality of sides connecting said first surface and said second surface; said microstructures being formed on said first surface of said optical base, each of which having a first bottom border, a second bottom border, and an arcuate arris; said first bottom border being formed in an expandable arc shape, and said second bottom border being formed in an expandable arc shape; said first bottom border intersecting with said second bottom border at a first interface and a second interface, respectively; said arcuate arris extending from said first interface toward said second interface; a first long-bevel face being defined between said arcuate arris and said first bottom border, and a second long-bevel face being defined between said arcuate arris and said second bottom border; said first long-bevel face and said second long-bevel face in cross-section being formed by a slope contour;
at least one brightness enhancement film covering said first surface of said optical base of said diffusion plate with the microstructures;
a light source being disposed under said second surface of said optical base of said diffusion plate; and
a reflecting plate being disposed below said light source.

7. The backlight module as claimed in claim 6, wherein said first long-bevel face and said second long-bevel face are axially reflected with each other by said arcuate arris.

8. The backlight module as claimed in claim 6, wherein said microstructures are distributed by rows; wherein, each row of said microstructures is aligned with respect to an axis line, and an angle defined between said arcuate arris and said axis line is in the range from 0 to 45 degrees.

9. The backlight module as claimed in claim 8, wherein said adjacent rows of said microstructures are in an interlaced distribution.

10. The backlight module as claimed in claim 8, wherein said microstructures are in a rectangular distribution.

11. The backlight module as claimed in claim 6, wherein said light source is a cold-cathode tube or a light emitting diode.

12. The backlight module as claimed in claim 6, wherein, said light source is axially arranged within the range from 0 to 90 degrees

13. An optical device having a diffusion plate with microstructures including:
a backlight module comprising at least one brightness enhancement film, said diffusion plate, a light source, and a reflecting plate; wherein, said diffusion plate comprising an optical base and a plurality of microstructures; said optical base having a first surface, a second surface disposed relatively to said first surface, and a plurality of sides connecting said first surface and said second surface; said microstructures being formed on said first surface of said optical base, each of which having a first bottom border, a second bottom border, and an arcuate arris; said first bottom border being formed in an expandable arc shape, and said second bottom border being formed in an expandable arc shape; said first bottom border intersecting with said second bottom border at a first interface and a second interface, respectively; said arcuate arris extending from said first interface toward said second interface; A first long-bevel face being defined between said arcuate arris and said first bottom border, and a second long-bevel face being defined between said arcuate arris and said second bottom border; said first long-bevel face and said second long-bevel face in cross-section being formed by a slope contour; said at least one brightness enhancement film covering said first surface of said optical base of said diffusion plate with said microstructures; said light source being disposed under said second surface of said optical base of said diffusion plate; said reflecting plate being disposed below said light source;
a circuit module electrically connecting to said backlight module; and
a frame module including a chamber to accommodate said backlight module and said circuit module therein.

14. The optical device as claimed in claim 13, wherein said first long-bevel face and said second long-bevel face are axially reflected with each other by said arcuate arris.

15. The optical device as claimed in claim 13, wherein said microstructures are distributed by rows; wherein, each row of said microstructures is aligned with respect to an axis line, and an angle defined between said arcuate arris and said axis line is in the range from 0 to 45 degrees.

16. The optical device as claimed in claim 15, wherein said adjacent rows of said microstructures are in an interlaced distribution.

17. The optical device as claimed in claim 15, wherein said microstructures are in a rectangular distribution.

18. The optical device as claimed in claim 13, wherein said light source is a cold-cathode tube or a light emitting diode.

19. The optical device as claimed in claim 13, wherein, said light source is axially arranged within the range from 0 to 90 degrees.
